(19) United States
(12) Patent Application Publication
(10) Pub. No.: US 2025/0368070 A1
(43) Pub. Date: Dec. 4, 2025

(54) Multiplexing Circuit, Method, and Controller of Inverter

(71) Applicant: Robert Bosch GmbH, Stuttgart (DE)

(72) Inventors: Xiang Lin, Shanghai (CN); Hao Yu, Shanghai (CN)

(21) Appl. No.: 19/218,922

(22) Filed: May 27, 2025

(30) Foreign Application Priority Data
May 31, 2024 (CN) 2024 1070 2570.9

(51) Int. Cl. B60L 53/24; B60L 50/51; B60L 50/60; B60L 53/16

(52) U.S. Cl. CPC B60L 53/24; B60L 50/51; B60L 50/60; B60L 53/16; B60L 2210/30; B60L 2210/40; B60L 2240/526; B60L 2270/147

(57) ABSTRACT

A multiplexing circuit, a method, and a controller of an inverter are disclosed. The multiplexing circuit of the inverter includes an inverter and a transformer. The inverter is used to connect the first power supply and the motor of the vehicle or to connect the first power supply and the second power supply. The transformer is used to connect the first power supply and the inverter when the inverter is connected to the first power supply and the second power supply. The examples of the present disclosure can transform the corrected voltage through a transformer so that the DC power supply can be charged based on the reuse of the inverter. It has a simple structure and high stability, avoids the problem of incompatibility between the inverter and the circuit when multiplexing, and improves the stability of the multiplexing circuit and the safety of the DC power supply.

This application claims priority under 35 U.S.C. § 119 to application no. CN 2024 1070 2570.9, filed on May 31, 2024 in China, the disclosure of which is incorporated herein by reference in its entirety.

The present disclosure relates to the field of electronic technology, and more particularly to a multiplexing circuit, a method, and a controller of an inverter.

### BACKGROUND

With the development of vehicles, new energy vehicles powered by batteries have gradually become part of the mainstream in the automotive field. New energy vehicles powered by batteries include pure electric vehicles, extended-range electric vehicles, fuel cell electric vehicles, etc., and their structures mainly involve battery systems, control systems, and charging systems.

In the above-mentioned new energy vehicles, the control systems further include vehicle control systems, motor control systems, auxiliary control systems, etc. Control systems often need to execute multiple sets of control logic. For example, when the vehicle is driving, the operating status of the motor needs to be controlled, and when the vehicle is charging, the charging logic of the battery needs to be controlled. Therefore, high-quality, high-reliability, and low-cost control systems are crucial for the above-mentioned new energy vehicles.

### Summary

Examples of the present disclosure provide a multiplexing circuit, a method, and a controller of an inverter.

In a first aspect of the present disclosure, a multiplexing circuit of an inverter is provided, comprising: an inverter configured to connect a first power supply and a motor of a vehicle, or configured to connect the first power supply and a second power supply; and a transformer configured to connect the first power supply and the inverter when the inverter connects the first power supply and the second power supply.

In a second aspect of the present disclosure, a method of multiplexing an inverter is provided. The method includes controlling an inverter to be connected between a first power supply of a vehicle and a motor or between the first power supply and a second power supply. The method further includes controlling the transformer to connect the first power supply and the inverter when the inverter connects the first power supply and the second power supply.

In a third aspect of the present disclosure, a controller is provided, including at least one processor; and a memory coupled to the at least one processor and having instructions stored thereon that, when executed by the at least one processor, cause the controller to execute the method provided according to the second aspect of the present disclosure.

In a fourth aspect of the present disclosure, a vehicle is provided, including the circuit provided according to the first aspect and/or the controller provided according to the third aspect.

The Summary is provided in part to introduce a selection of concepts in a simplified form, which will be further described in the embodiments below. The Summary is not intended to identify key or primary features of the disclosure, nor is it intended to limit the scope of the disclosure.

### BRIEF DESCRIPTION OF THE DRAWINGS

The exemplary examples of the present disclosure will be described in further detail in conjunction with accompanying drawings in order to further clarify the above-mentioned and other objectives, features, and advantages of the present disclosure, wherein in the exemplary examples of the present disclosure, the same reference number typically represents the same part.

FIG. 1 shows a block diagram of a multiplexing circuit of an inverter according to some examples of the present disclosure;

FIG. 2 shows a schematic diagram of a transformer for stepping down voltage according to some examples of the present disclosure;

FIG. 3 shows a schematic diagram of a transformer for stepping up voltage according to some examples of the present disclosure;

FIG. 4 shows a schematic diagram of a transformer for stepping down and stepping up voltage according to some examples of the present disclosure;

FIG. 5 shows a schematic diagram of a multiplexing circuit of an inverter according to some examples of the present disclosure;

FIG. 6 shows another schematic diagram of a multiplexing circuit of an inverter according to some examples of the present disclosure;

FIG. 7 shows a schematic diagram of an inverter according to some examples of the present disclosure; and

FIG. 8 shows a flowchart of a method of multiplexing an inverter according to some examples of the present disclosure.

### DETAILED DESCRIPTION

The examples of the present disclosure will be described in further detail below with reference to the accompanying drawings. Although examples of the present disclosure are shown in the drawings, it should be understood that the present disclosure can be implemented in various forms and should not be limited to the examples set forth herein. Rather, these examples are provided for the purpose of making the disclosure more thorough and complete and are capable of conveying the scope of the disclosure completely to those skilled in the art. Those skilled in the art can derive alternative technical solutions from the following description without departing from the spirit and scope of protection of the present disclosure.

As used herein, the term “comprise” and variations thereof mean open inclusion, i.e., “including but not limited to”. Unless specifically stated, the term “or” means “and/or”. The term “based on” means “at least partially based on”. The term “an example” means “at least one exemplary example”. Other explicit and implicit definitions may be included below.

As noted above, control systems are a core component of new energy vehicles powered by batteries, and various components are involved in control systems, such as traction inverters. When the vehicle is running, the traction inverter is used to invert the DC power output by the DC power supply into AC power suitable for the vehicle motor. During vehicle charging, an onboard charger (OBC) including power factor correction (PFC) is used to convert the current output from the grid into a current suitable for DC power supply charging. Since the electronic components required for different modes and functions of the vehicle are different and cannot be reused, the vehicle's control system often has problems such as high hardware cost, large size, and large quantity, which increase the cost of using the vehicle. At the same time, if the transistors in the inverter are used directly as devices in power factor correction, the transistors in the inverter may not be adapted to the circuitry of the onboard charger, thereby causing damage to the DC power supply of the vehicle.

An example of the present disclosure provides a multiplexing circuit of an inverter. In this multiplexing circuit, the inverter is used to connect a DC power supply and motor or to connect a DC power supply and an external power supply. In the process of the inverter connecting the DC power supply and the external power supply to charge the DC power supply, the corrected voltage is transformed by the transformer so that the DC power supply can be adaptively charged based on the inverter. The structure is simple and stability is high, avoiding the problem of incompatibility with the circuit when the inverter is reused and improving the stability of the control system and the safety of the DC power supply.

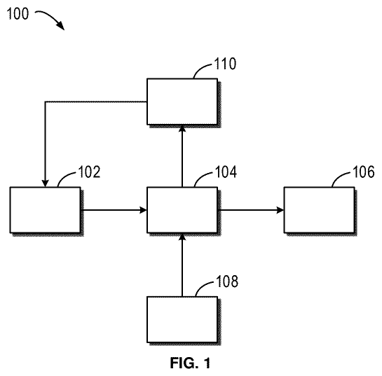

FIG. 1 shows a block diagram of a multiplexing circuit 100 of an inverter according to some examples of the present disclosure. With reference to FIG. 1, the multiplexing circuit 100 of the inverter includes an inverter 104 configured to connect a first power supply 102 of a vehicle to a motor 106 or configured to connect the first power supply 102 to the second power supply 108; and a transformer 110 configured to connect the first power supply 102 to the inverter 104 when the inverter 104 connects the first power supply 102 to the second power supply 108.

In some examples, when the vehicle is in a driving state, the motor 106 obtains power from the first power supply 102 and drives the vehicle to drive. The inverter 104 is connected between the first power supply 102 and the motor 106. For example, the motor 106 is an AC motor, which may include a three-phase AC motor, a single-phase AC motor, etc. A plurality of transistors can be included in the inverter 104 to realize the inverter function of the inverter 104 by controlling the on-off of the plurality of transistors, thereby obtaining an alternating current adapted to the motor 106. When the vehicle is in a charging state, the first power supply 102 obtains power from the second power supply 108. The inverter 104 is connected between the second power supply 108 and the first power supply 102 to correct the output power of the second power supply 108 by a plurality of transistors to obtain a charging power adapted to the first power supply 102.

In some examples, when the vehicle is in a charging state, a transformer 110 is further provided between the inverter 104 and the first power supply 102 for transforming the output voltage of the inverter 104 so that the corrected voltage is adapted to the first power supply 102. When the voltage corrected by the inverter 104 is higher than the charging voltage of the first power supply 102, the transformer 110 is used to step down the voltage corrected by the inverter 104; when the voltage corrected by the inverter 104 is lower than the charging voltage of the first power supply 102, the transformer 110 is used to step up the voltage corrected by the inverter 104.

In some examples, the first power supply 102 is a DC power supply of the vehicle, including but not limited to a lithium iron phosphate battery, a ternary lithium battery, a lead-acid battery, a nickel-metal hydride battery, etc. or any combination of the above batteries and the second power supply 108 is an AC power supply, such as a grid power supply. It should be understood that the enumeration here is only for the purpose of explaining the first and second power supplies 102 and 108, without creating restrictions on the first and second power supplies 102 and 108.

In this way, in the multiplexing circuit 100, the inverter 104 is used to connect the first power supply 102 and the motor 106 or to connect the first power supply 102 and the second power supply 108. In the process of the inverter 104 connecting the first power supply 102 and the second power supply 108 to charge the first power supply 102, the corrected voltage is transformed by the transformer to allow the first power supply 102 to be charged adaptively based on the inverter 104. The structure is simple and the stability is high, which avoids the problem of incompatibility between the inverter 104 and the circuit 100 when multiplexing, thereby improving the stability of the circuit 100 and the safety of the first power supply 102.

In some examples, the transformer 110 includes a first group of transistors, a first capacitor C1, and a first inductor L1, wherein the first capacitor C1 is connected in parallel with the first power supply 102 and the first group of transistors is configured to connect the inverter 104 and the first capacitor C1 to the first discharge loop of the first inductor L1 when the transformer 110 steps up the voltage or is configured to connect the first capacitor C1 to the second discharge loop of the first inductor L1 and disconnect the inverter 104 from the first inductor L1 when the transformer 110 steps down the voltage.

In some examples, the transformer 110 is provided with a plurality of transistors (which may be referred to as a first group of transistors), a capacitor C1, and an inductor L1 and the capacitor C1 and the first power supply 102 are connected in parallel. It should be understood that the terminal voltage of the capacitor C1 is the input voltage of the first power supply 102 during charging. When the output voltage of the inverter 104 is higher than the charging voltage of the first power supply 102, the transformer 110 operates in a step-down state and the states of a plurality of transistors are set so that when the inductor L1 is discharged, the capacitor C1 is connected to the discharge loop (which may be referred to as a second discharge loop) and the inverter 104 is not connected to the discharge loop. At this time, the charging voltage of the first power supply 102 (i.e., the terminal voltage of the capacitor C1) is determined by the inductor L1. When the output voltage of the inverter 104 is lower than the charging voltage of the first power supply 102, the transformer 110 operates in a step-up state and the states of a plurality of transistors are set so that when the inductor L1 is discharged, the capacitor C1 and the inverter 104 are both connected to the discharge loop (which may be referred to as a first discharge loop). At this time, the charging voltage of the first power supply 102 is jointly determined by the output voltage of the inductor L1 and the inverter 104.

In this way, the inverter 104 is used to perform current inversion and power correction in the multiplexing circuit 100. During the charging process of the first power supply 102, the corrected voltage is transformed by the transformer 110 and the connection method of the capacitor C1 and the inductor L1 is adjusted based on the plurality of transistors in the transformer 110 to step up or step down voltage. The structure is simple and stability is high, avoiding the problem of incompatibility with the circuit when the inverter 104 is reused and improving the stability of the control system and the safety of the first power supply 102.

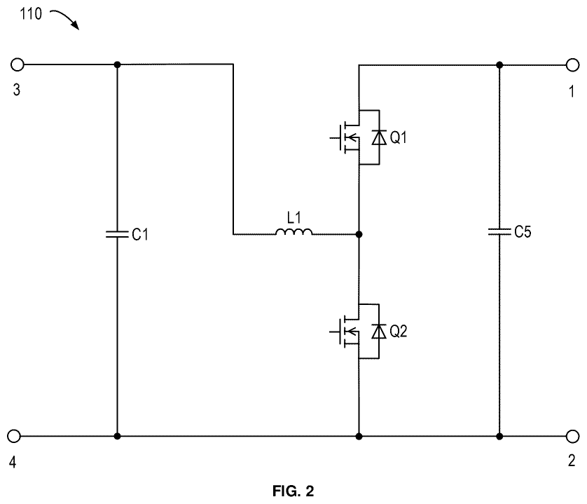

FIG. 2 shows a schematic diagram of a transformer 110 for stepping down voltage according to some examples of the present disclosure. In some examples, the plurality of transistors in the transformer 110 includes a transistor Q1 and a transistor Q2, the inverter 104, the transistor Q1, and the transistor Q2 are connected to form a loop, and the capacitor C1 and the inductor L1 are connected in series and then connected in parallel with the transistor Q2. With reference to FIG. 2, interface 1 and interface 2 of the transformer 110 are connected to the inverter 104, interface 3 and interface 4 are connected to the first power supply 102, and the capacitor C5 is a voltage stabilizing capacitor. As switch tubes, transistor Q1 and transistor Q2 can be turned on and off at a certain frequency, thereby forming a continuous voltage step-down cycle. It should be understood that in each step-down cycle, the inductor L1 obtains the corrected power of the second power supply 108 from the inverter 104 in the charging phase (which may be referred to as the first charging phase) and discharges to the first power supply 102 in the discharging phase (which may be referred to as the first discharging phase).

In the charging phase of the inductor L1, the transistor Q1 is turned on and the transistor Q2 is turned off. At this time, the current corrected by the inverter 104 passes through the inductor L1 and the capacitor C1 and the inductor L1 is charged. In the discharging phase of the inductor L1, the transistor Q1 is turned off and the transistor Q2 is turned on. The inverter 104 is disconnected from the inductor L1 and the current output from the inductor L1 passes through the capacitor C1 and the first power supply 102 to discharge (at this time, a second discharge loop of the inductor L1 is formed). At this time, the input voltage of the first power supply 102 is the terminal voltage of the capacitor C1. In this way, the first power supply 102 can be continuously stepped down and charged by periodically switching the conduction states of transistor Q1 and transistor Q2. The control logic is simple and only requires generating adjustment signals for transistor Q1 and transistor Q2, thereby reducing the cost of transformer 110.

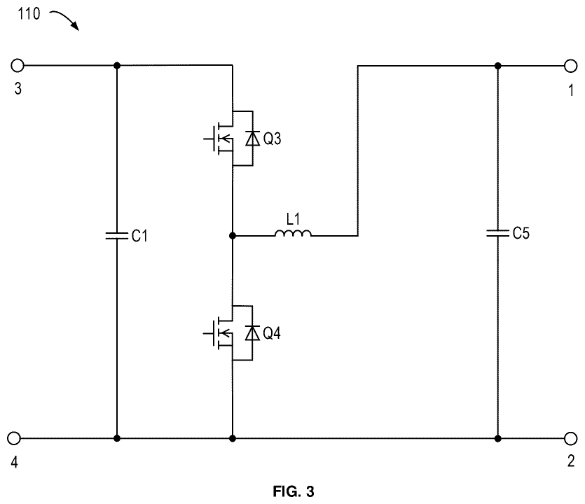

FIG. 3 shows a schematic diagram of a transformer 110 for stepping up voltage according to some examples of the present disclosure. In some examples, the plurality of transistors in the transformer 110 includes a transistor Q3 and a transistor Q4, the inverter 104, the inductor L1, and the transistor Q4 are connected to form a loop, and the transistor Q3 and the capacitor C1 are connected in series and then connected in parallel with the transistor Q4. With reference to FIG. 3, interface 1 and interface 2 of the transformer 110 are connected to the inverter 104, interface 3 and interface 4 are connected to the first power supply 102, and the capacitor C5 is a voltage stabilizing capacitor. As switch tubes, transistor Q3 and transistor Q4 can be turned on and off at a certain frequency, thereby forming a continuous voltage step-up cycle. It should be understood that in each step-up cycle, the inductor L1 obtains the corrected power of the second power supply 108 from the inverter 104 in the charging phase (which may be referred to as the second charging phase) and discharges to the first power supply 102 in the discharging phase (which may be referred to as the second discharging phase).

In the charging phase of the inductor L1, the transistor Q4 is turned on. At this time, the current corrected by the inverter 104 passes through the inductor L1 and the inductor L1 is charged. In the discharging phase of the inductor L1, the transistor Q3 is turned on and the transistor Q4 is turned off. The current output from the inductor L1 and the inverter 104 passes through the capacitor C1 and the first power supply 102 (forming a first discharge loop of the inductor L1). The capacitor C1 and the inverter 104 are both connected in the discharge loop. At this time, the charging voltage of the first power supply 102 is jointly determined by the output voltage of the inductor L1 and the inverter 104. Specifically, at this time, the charging voltage of the first power supply 102, that is, the terminal voltage of the capacitor C1, is the sum of the terminal voltage of the inductor L1 and the terminal voltage of the inverter 104. In this way, the first power supply 102 can be continuously stepped up and charged by periodically switching the conduction states of transistor Q3 and transistor Q4. The control logic is simple and only requires generating adjustment signals for transistor Q3 and transistor Q4, thereby reducing the cost of transformer 110.

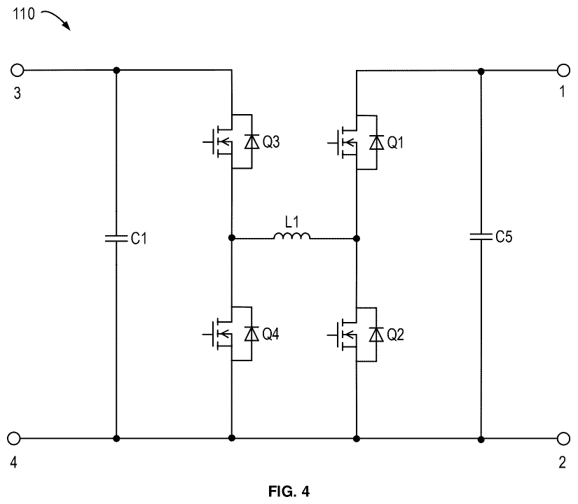

FIG. 4 shows a schematic diagram of a transformer 110 for stepping down and stepping up voltage according to some examples of the present disclosure. In some examples, a first end of the inductor L1 is connected to the transistor Q1 and the transistor Q2 and a second end of the inductor L1 is connected to the transistor Q3 and the transistor Q4. When the transformer 110 is operating in a step-down state, the transistor Q3 is turned on and the transistor Q4 is turned off (that is, the transformer 110 operates in the state shown in FIG. 2). At this time, by periodically switching the conduction states of the transistors Q1 and Q2, the step-down charging of the first power supply 102 can be achieved. When the transformer 110 is operating in a step-up state, the transistor Q1 is turned on and the transistor Q2 is turned off (that is, the transformer 110 operates in the state shown in FIG. 3). At this time, by periodically switching the conduction states of the transistors Q3 and Q4, the step-up charging of the first power supply 102 can be achieved. In this way, switching between the step-up state and the step-down state of the transformer 110 can be achieved based on controlling the conduction state of the transistors Q1, Q2, Q3, and Q4. The switching logic is simple and easy to implement, thereby reducing the cost of the transformer 110.

In some examples, with reference to FIGS. 2-4, transistor Q1, transistor Q2, transistor Q3, and transistor Q4 are each configured as a field effect transistor (FET) and a diode connected in parallel. A field effect transistor is a semiconductor device that uses the electric field effect of the input circuit to control the current of the output circuit and a diode is an electronic component with the characteristic of unidirectional current conduction. The conduction control logic of the above-mentioned transistor Q1, transistor Q2, transistor Q3, and transistor Q4 is realized by the field effect transistors and diodes connected in parallel. In this way, a variety of conduction control logic can be implemented for each transistor, thereby achieving step-up control and step-down control of the transformer 110.

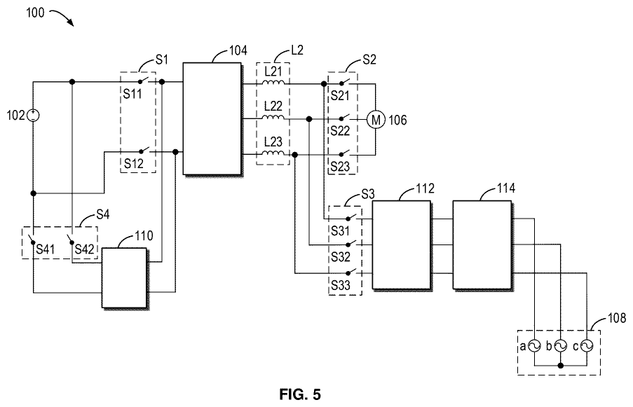

FIG. 5 shows a schematic diagram of a multiplexing circuit 100 of an inverter according to some examples of the present disclosure. In some examples, the circuit 100 includes a group of switches, namely switches S1 and S2 (which may be referred to as a first group of switches), connected between the first power supply 102 and the motor 106 and a group of switches, namely switches S3 and S4 (which may be referred to as a second group of switches), connected between the first power supply 102 and the second power supply 108. When the switches S1 and S2 are turned on and the switches S3 and S4 are turned off, the inverter 104 is connected between the first power supply 102 and the motor 106. At this time, the inverter 104 is used to invert the current output by the first power supply 102. When the switches S1 and S2 are turned off and the switches S3 and S4 are turned on, the inverter 104 is connected between the first power supply 102 and the second power supply 108. At this time, the inverter 104 is used to correct the output power of the second power supply 108. In this way, based on the on-off control of a group of switches S1 and S2 and a group of switches S3 and S4, the inverter 104 can be connected to different working circuits to switch the working state of the inverter 104. The switching logic is simple, thereby reducing the cost of the circuit 100.

In some examples, the switch S1 includes a switch S11 and a switch S12 connected between the first power supply 102 and the inverter 104 for controlling a current loop between the first power supply 102 and the inverter 104. The switch S2 includes a switch S21, a switch S22, and a switch S23, which are respectively connected between the inverter 104 and the motor 106. When the inverter 104 is connected to the motor 106, the number of switches S21, S22, and S23 that are turned on can be set according to the number of inputs of the motor 106, that is, whether the motor 106 is a three-phase AC motor or a single-phase AC motor. In this way, switching of the motor 106 between the three-phase input and the single-phase input may be achieved based on the control of the switch S21, switch S22, and switch S23, thereby improving the application range of the circuit 100.

In some examples, the switch S3 includes a switch S31, a switch S32, and a switch S33 and the switch S31, the switch S32, and the switch S33 are respectively connected between the inverter 104 and the second power supply 108. When the inverter 104 is connected to the second power supply 108, the number of switch S31, switch S32, and switch S33 that are turned on may be determined based on the number of outputs of the second power supply 108, i.e., whether the second power supply 108 is a single-phase or a three-phase power supply. The switch S4 includes a switch S41 and a switch S42 connected between the first power supply 102 and the transformer 110 for controlling the current loop between the transformer 110 and the first power supply 102. In this way, switching of the second power supply 108 between single-phase output and three-phase output may be achieved based on the control of the switch S31, the switch S32, and the switch S33, thereby improving the application range of the circuit 100.

In some examples, the circuit 100 further includes an inductor L2, wherein the inductor L2 includes an inductor L21, an inductor L22 and an inductor L23 and the inductor L21, the inductor L22, and the inductor L23 are respectively connected between the inverter 104 and the motor 106 for adjusting the instantaneous current flowing from the inverter 104 to the motor 106. In this way, the stability of the input current of the motor 106 may be ensured to avoid damage to the motor 106 due to transient current, thereby increasing the stability of the circuit 100.

In some examples, the second power supply 108 is a grid power supply, the circuit 100 includes a socket 114 for connecting a charging plug of a vehicle and an AC filter 112 for filtering the AC power flowing out of the socket 114 connected between the inverter 104 and the socket 114. In this way, the stability of the current can be improved and electromagnetic interference reduced.

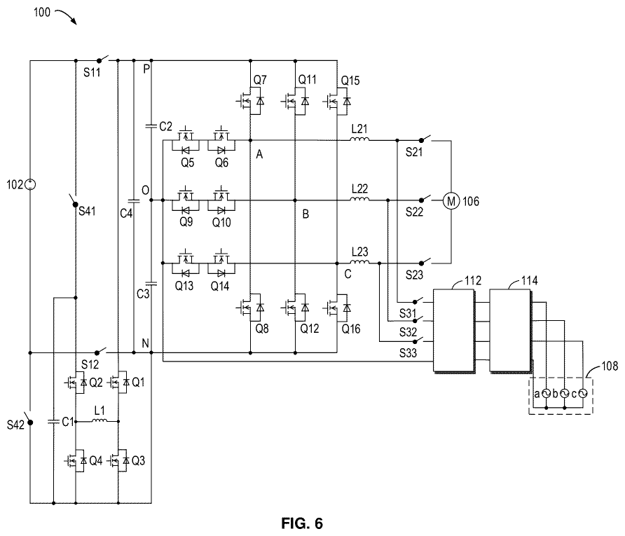

FIG. 6 shows another schematic diagram of a multiplexing circuit 100 of an inverter according to some examples of the present disclosure. In some examples, the inverter 104 includes a capacitor C2 and a capacitor C3, which are connected in series and then connected in parallel to the first power supply 102. The inverter 104 also includes at least one group of transistors (which may be referred to as a second group of transistors). For example, the group of transistors includes a transistor Q5, a transistor Q6, a transistor Q7, and a transistor Q8. The first end of the transistor Q5 is connected between the capacitor C2 and the capacitor C3, the second end is connected to the first end of the transistor Q6 and forms a backward connection with the transistor Q6, the second end of the transistor Q6 is connected between the transistor Q7 and the transistor Q8, and the transistor Q6, the transistor Q7, and the transistor Q8 are simultaneously connected to an input of the motor 106. The inverter 104 forms a T-type three- level inverter.

With reference to FIG. 6, capacitor C2 and capacitor C3 are capacitors with the same parameters. Point P in the circuit 100 is connected to the positive electrode of the first power supply 102, point N is connected to the negative electrode of the first power supply 102, point O is the central potential point between point P and point N, and points A, B, and C are respectively connected to the three phase input ports of the motor 106. In some examples, the circuit 100 further includes a capacitor C4 for stabilizing the output voltage of the first power supply 102.

With reference to FIG. 6, at least one group of transistors may also include transistor Q9, transistor Q10, transistor Q11, transistor Q12, transistor Q13, transistor Q14, transistor Q15, and transistor Q16. The connection relationship between transistor Q9, transistor Q10, transistor Q11, and transistor Q12 and the connection relationship between transistor Q13, transistor Q14, transistor Q15, and transistor Q16 are similar to the connection relationship between transistor Q5, transistor Q6, transistor Q7, and transistor Q8 and will not be repeated in the present disclosure. In some examples, the inductor L21, the inductor L22, and the inductor L23 are respectively connected between the three groups of transistors and the input of the motor 106.

Compared with other types of inverters, the inverter 104 in this example has lower energy loss, better electromagnetic compatibility and motor isolation capability, and better adaptability to different voltage environments, such as an 800V voltage environment.

The inverter 104 composed of the capacitor C2, the capacitor C3, and the transistors Q5 to Q16 can also be used for power factor correction in the charging circuit when the first power supply 102 is charged. The charging circuit of the first power supply 102 in the present disclosure may be used in a voltage environment of 220V or 380V. Depending on the number of phases of the second power supply 108, the charging circuit can be either a single-phase circuit or a three-phase circuit. In addition, the charging circuit may also be adapted to operate in a current environment of 16A, 32A, and 63A and the operating power of the charging circuit may vary from 7KW to 40KW. It should be understood that the above are merely examples of charging circuits in the present disclosure and the present disclosure does not impose any limitation on the charging circuits. The multiplexing process of the inverter 104 will be described in detail below with reference to FIG. 6.

In some examples, during the operation of the motor 106 (when the first power supply 102 is in the first discharge state), switches S11, S12, S21, S22, and S23 are turned on, switches S31, S32, S33, S41, and S42 are turned off, and the inverter 104 (including capacitor C2, capacitor C3, and transistors Q5-Q16) is connected between the first power supply 102 and the motor 106 and acts as a T-type three-level inverter to invert the output current of the first power supply 102.

In some examples, during charging of the first power supply 102 (i.e., the first power supply 102 is in the first charging state), switches S11, S12, S21, S22, and S23 are turned off and the switches S31, S32, S33, S41, and S42 are turned on. The current flows from the second power supply 108, the socket 114, the AC filter 112, inductors L21-L23, the inverter 104 (including capacitor C2, capacitor C3, and transistors Q5-Q16), and the transformer 110 (including capacitor C1, inductor L1, and transistors Q1-Q4) into the first power supply 102.

When the second power supply 108 is a three-phase power supply, the inverter 104 acts as three-phase power factor correction. When the second power supply 108 is a single-phase power supply, any of the switches S31, S32, and S33 is turned off and the inverter 104 acts as single-phase power factor correction. When the output voltage of the inverter 104 is higher than the charging voltage of the first power supply 102, the transformer 104 enters the step-down mode. When the output voltage of the inverter 104 is lower than the charging voltage of the first power supply 102, the transformer 104 enters the step-up mode.

In some examples, when the first power supply 102 is used to supply power to an external device (i.e., the first power supply 102 is in the second discharge state), the switch S11, the switch S12 (collectively referred to as the first switch S1), the switch S31, the switch S32, and the switch S33 (collectively referred to as the third switch S3) are turned on, the switch S21, the switch S22, the switch S23 (collectively referred to as the second switch S2), the switch S41, and the switch S42 (collectively referred to as the fourth switch S4) are turned off, the inverter 104 is used to invert the current output by the first power supply 102, and the inverted current flows into the external device through the switch S31, the switch S32, and the switch S33 so that the inverted current can be adapted to the external device, such as household appliances or camping equipment. It should be understood that during the process of supplying power to the external device, since the socket 114 is always in a disconnected state, the second power supply 108 will not be connected to the circuit 100.

In some examples, when the vehicle is in the kinetic energy recovery phase (when the first power supply 102 is in the second charging state), switch S21, switch S22, switch S23 (collectively referred to as the second switch S2), switch S41, and switch S42 (collectively referred to as the fourth switch S4) are turned on and switch S11, switch S12 (collectively referred to as the first switch S1), switch S31, switch S32, and switch S33 (collectively referred to as the third switch S3) are turned off. At this time, the inverter 104 is used as power factor correction to correct the power output by the motor 106 and the transformer 106 transforms the voltage corrected by the inverter 104.

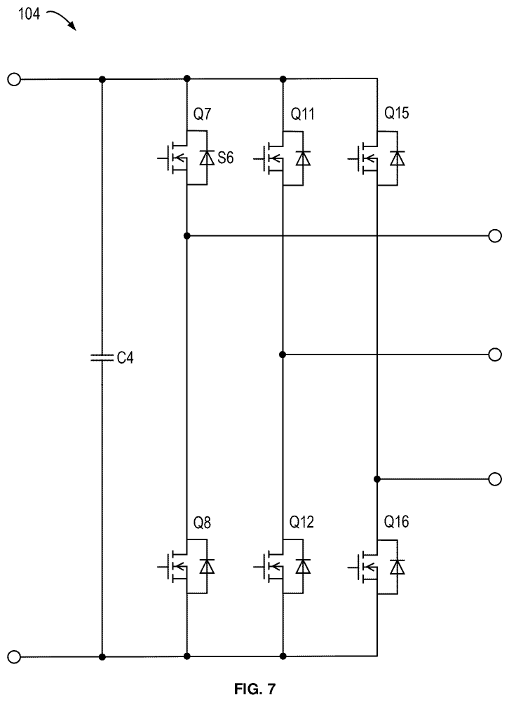

FIG. 7 shows a schematic diagram of an inverter 104 according to some examples of the present disclosure. In some examples, the present disclosure also provides another inverter different from the inverter shown in FIG. 6. With reference to FIG. 7, the inverter 104 includes three groups of transistors, respectively transistor Q7 and transistor Q8, transistor Q11 and transistor Q12, and transistor Q15 and transistor Q16. Transistor Q7 and transistor Q8 are connected in parallel with the first power supply 102 after being connected in series and one of the inputs of the motor 106 is connected to transistor Q7 and transistor Q8 simultaneously. The connection relationship between transistor Q11 and transistor Q12 and the connection relationship between transistor Q15 and transistor Q16 are similar to the connection relationship between transistor Q7 and transistor Q8 and will not be repeated in the present disclosure. The capacitor C4 is used as a voltage stabilizing capacitor to stabilize the output voltage of the first power supply 102.

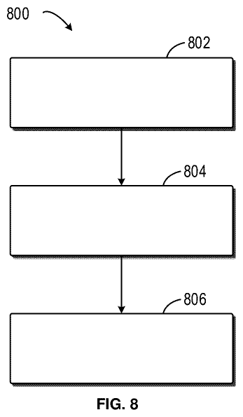

FIG. 8 shows a flowchart of a method 800 of multiplexing an inverter according to some examples of the present disclosure. In some examples, the method 800 may be executed by a controller of a vehicle and the control objects involved in the method 800 may include, for example, the various electronics in FIGS. 1-8. It should be understood that the method 800 may also comprise additional actions not shown and/or actions that may be omitted as shown, the scope of the present disclosure being not limited in this regard. The control process shown in FIG. 8 has been described in detail above and will not be described in detail here.

At 802, with the inverter 104 connected between the first power supply 102 and the second power supply 108, the state of the transformer 110 is determined 802. The states of the transformer 110 include a step-up state and a step-down state. In some examples, the controller may first determine the voltage output by the inverter 104 after correcting the power of the second power supply 108 and compare the voltage output by the inverter 104 with the rated charging voltage of the first power supply 102, thereby determining whether the state of the transformer 110 is a step-up state or a step-down state based on the voltage comparison result.

At 804, based on the state of the transformer 110, a first control signal for a group of transistors in the transformer 110 is generated 804. In some examples, the first control signal is a periodic signal, such as a pulse signal. The first pulse signal may cause the transistors in the group of transistors to be periodically turned on and off.

At 806, a first control signal is sent 806 to a group of transistors to control the transformer 110 so that when the voltage is stepped up, the inverter 104 and the first capacitor C1 are connected to the first discharge loop of the first inductor L1 and to control the transformer 110 so that when the voltage is stepped down, the first capacitor C1 is connected to the second discharge loop of the first inductor L1 and the inverter 104 is disconnected from the first inductor L1, wherein the first capacitor C1 is connected in parallel with the first power supply 102.

In this way, the inverter 104 is used to perform current inversion and power correction in the multiplexing circuit 100. During the charging process of the first power supply 102, the corrected voltage is transformed by the transformer 110 and the connection method of the capacitor C1 and the inductor L1 is adjusted based on the plurality of transistors in the transformer 110 to step up or step down voltage. The structure is simple and stability is high, avoiding the problem of incompatibility with the circuit when the inverter 104 is reused and improving the stability of the control system and the safety of the first power supply 102.

In some examples, the controller determines the state of the first power supply 102, generates a control signal (which may be referred to as a second control signal) according to the state of the first power supply 102 and sends it to switch S11, switch S12, switch S21, switch S22, and switch S23 (collectively referred to as a first group of switches) and switch S31, switch S32, switch S33, switch S41, and switch S42 (collectively referred to as a second group of switches). Switch S11, switch S12, switch S21, switch S22, and switch S23 are connected between the first power supply 102 and motor 106 and S31, switch S32, switch S33, switch S41, and switch S42 are connected between the first power supply 102 and the second power supply 108.

In some examples, a battery management system (BMS) is present in the vehicle for monitoring and managing the first power supply 102. The battery management system can monitor electrical parameters of the first power supply 102, such as voltage, temperature, current, remaining power, and health, and switch the state of the first power supply 102 based on the electrical parameters of the first power supply 102. The battery management system can determine the state of the first power supply 102 based on the monitored electrical parameters and adjust the connection mode of the first power supply 102, for example: when it is detected that the vehicle is in the power output stage, the circuit between the first power supply 102 and the motor 106 is controlled to be connected to supply power to the motor 106; when it is detected that the vehicle is still moving but there is no power output, the circuit between the motor 106 and the first power supply 102 is controlled to be connected to recover the kinetic energy of the motor 106; when it is detected that the first power supply 102 needs to be charged and the socket 114 is already connected to the second power supply 108, the circuit between the first power supply 102 and the second power supply 108 is controlled to be connected to charge the first power supply 102; and when it is detected that the vehicle is connected to an external device, the circuit between the first power supply 102 and the outside is controlled to be connected to supply power to the external device.

If the first power supply 102 is in the charging state to obtain power from the second power supply 108, the controller controls switch S11, switch S12, switch S21, switch S22, and switch S23 (also referred to as a first group of switches) to open and controls switch S31, switch S32, switch S33, switch S41, and switch S42 to close. If the first power supply 102 is in the discharging state to provide power to the motor 106, the controller controls switch S11, switch S12, switch S21, switch S22, and switch S23 to close and controls switch S31, switch S32, switch S33, switch S41, and switch S42 to open. Through this control method, circuit switching of the inverter 104 can be achieved based on the controller controlling the two groups of switches.

In some examples, switch S1 is connected between the first power supply 102 and the inverter 104, switch S2 is connected between the inverter 104 and the motor 106, switch S3 is connected between the second power supply 108 and the inverter 104, and switch S4 is connected between the first power supply 102 and the transformer 110. When the controller determines that the first power supply 102 is in a state of discharging to an external device, the controller controls switch S1 and switch S3 to close and controls switch S2 and switch S4 to open through control signals. When the controller determines that the first power supply 102 needs to obtain recovered power from the motor 106, the controller controls switch S2 and switch S4 to close and controls switch S1 and switch S3 to open through control signals. In this way, the functionality of the fast-switching circuit 100 may be controlled by a controller by turning on and off switches S1-S4.

Many modifications and other embodiments of the present disclosure set forth herein will come to mind to one skilled in the art to which the present disclosure pertains given herein in view of the teachings presented in the foregoing descriptions and the associated drawings. Accordingly, it is to be understood that embodiments of the present disclosure are not limited to the specific embodiments disclosed and that modifications and other embodiments are intended to be included within the scope of the present disclosure. Furthermore, while the above description and the accompanying drawings describe example implementations in the context of certain example combinations of components and/or functions, it should be appreciated that different combinations of components and/or functions may be provided by alternative implementations without departing from the scope of the present disclosure. In this regard, for example, other combinations of components and/or functionality than those explicitly described above are also contemplated to be within the scope of the present disclosure. Although specific terms are used herein, they are used only in a general and descriptive sense and are not intended to be limiting.

The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The selection of terms used herein aims to best explain the principles and actual applications of various examples as well as the technological improvements in the technology in the market, or allow others of ordinary skill in the art to understand various examples disclosed herein.

What is claimed is:

1. A multiplexing circuit of an inverter, comprising:
an inverter configured to connect a first power supply and a motor of a vehicle, or configured to connect the first power supply and a second power supply; and
a transformer configured to connect the first power supply and the inverter when the inverter connects the first power supply and the second power supply.

2. The circuit according to claim 1, wherein the transformer comprises:
a first group of transistors, a first capacitor, and a first inductor, wherein the first capacitor is connected in parallel with the first power supply and the first group of transistors is configured to connect the inverter and the first capacitor to the first discharge loop of the first inductor when the transformer steps up the voltage or is configured to connect the first capacitor to the second discharge loop of the first inductor and disconnect the inverter from the first inductor when the transformer steps down the voltage.

3. The circuit according to claim 2, wherein the first group of transistors comprises:
a first transistor and a second transistor, wherein the inverter, the first transistor, and the second transistor are connected to form a loop, and the first capacitor and the first inductor are connected in series and then connected in parallel with the second transistor; and
in a first charging phase of the first inductor, the first transistor is turned on and the second transistor is turned off, in a first discharging phase of the first inductor, the first transistor is turned off and the second transistor is turned on, and the first charging phase and the first discharging phase form a step-down cycle.

4. The circuit according to claim 3, wherein the first group of transistors further comprises:
a third transistor and a fourth transistor, wherein the inverter, the first inductor, and the fourth transistor are connected to form a loop, and the third transistor and the first capacitor are connected in series and then connected in parallel with the fourth transistor; and
in a second charging phase of the first inductor, the fourth transistor is turned on, in a second discharging phase of the first inductor, the third transistor is turned on and the fourth transistor is turned off, and the second charging phase and the second discharging phase form a step-up cycle.

5. The circuit according to claim 4, wherein:
a first end of the first inductor is connected to the first transistor and the second transistor, and a second end is connected to the third transistor and the fourth transistor;
when the transformer steps down the voltage, the third transistor is turned on and the fourth transistor is turned off; and
when the transformer steps up the voltage, the first transistor is turned on and the second transistor is turned off.

6. The circuit according to claim 1, wherein the inverter comprises:
a second capacitor and a third capacitor, wherein the second capacitor and the third capacitor are connected in series and then connected in parallel with the first power supply; and
a second group of transistors, including a fifth transistor, a sixth transistor, a seventh transistor, and an eighth transistor, wherein a first end of the fifth transistor is connected between the second capacitor and the third capacitor, a second end is connected to a first end of the sixth transistor and forms a backward connection with the sixth transistor, a second end of the sixth transistor is connected between the seventh transistor and the eighth transistor, and the sixth transistor, the seventh transistor, and the eighth transistor are simultaneously connected to an input of the motor.

7. The circuit according to claim 6, wherein the inverter further comprises:
a second inductor connected between the second group of transistors and the motor and configured to adjust an instantaneous current flowing from the second group of transistors into the motor.

8. The circuit according to claim 1, further comprising:
a first group of switches connected between the first power supply and the motor; and
a second group of switches connected between the first power supply and the second power supply, wherein:
when the first group of switches is turned on and the second group of switches is turned off, the inverter connects the first power supply and the motor, and when the first group of switches is turned off and the second group of switches is turned on, the inverter connects the first power supply and the second power supply.

9. The circuit according to claim 8, wherein the first group of switches comprises:
a first switch connected between the first power supply and the inverter; and
at least three second switches connected between the inverter and the motor and the number of second switches that are turned on is determined based on the number of inputs of the motor.

10. The circuit according to claim 9, wherein the second group of switches comprises:
at least three third switches connected between the second power supply and the inverter and the number of third switches that are turned is determined based on the number of outputs of the second power supply; and
a fourth switch connected between the transformer and the first power supply.

11. The circuit according to claim 10, wherein:
when the first switch and the third switch are turned on and the second switch and the fourth switch are turned off, the inverter is further configured to invert the current output by the first power supply so that the inverted current is suitable for an external device; and
when the second switch and the fourth switch are turned on and the first switch and the third switch are turned off, the inverter is further configured to correct the power output by the motor and the transformer is further configured to transform the voltage corrected by the inverter to obtain a voltage suitable for the first power supply.

12. A method of multiplexing an inverter, comprising:
controlling the inverter to be connected between the first power supply and the motor of the vehicle or between the first power supply and the second power supply; and
when the inverter is connected to the first power supply and the second power supply, controlling the transformer to connect the first power supply and the inverter.

13. The method according to claim 12, further comprising:
when the inverter is connected between the first power supply and the second power supply, determining a state of the transformer, the states of the transformer comprising a step-up state and a step-down state;
generating a first control signal for a group of transistors in the transformer based on the state of the transformer; and
sending the first control signal to a group of transistors to control the transformer so that when the voltage is stepped up, the inverter and the first capacitor are connected to the first discharge loop of the first inductor or to control the transformer so that when the voltage is stepped down, the first capacitor is connected to the second discharge loop of the first inductor and the inverter is disconnected from the first inductor, wherein the first capacitor is connected in parallel with the first power supply.

14. The method according to claim 12, further comprising:
determining a state of the first power supply;
generating a second control signal for a first group of switches and a second group of switches based on the state of the first power supply, wherein the first group of switches is connected between the first power supply and the motor and the second group of switches is connected between the first power supply and the second power supply; and
sending the second control signal to the first group of switches and the second group of switches to control the first group of switches to turn on and the second group of switches to turn off or to control the first group of switches to turn off and the second group of switches to turn on.

15. The method according to claim 13, wherein the first group of switches comprises a first switch connected between the first power supply and the inverter and a second switch connected between the inverter and the motor, the second group of switches comprises a third switch connected between the second power supply and the inverter and a fourth switch connected between the transformer and the first power supply, and the second control signal is further used to control the first switch, the second switch, the third switch, and the fourth switch to be in one of the following states:
the first switch and the second switch turned on and the third switch and the fourth switch turned off;
the first switch and the second switch turned off and the third switch and the fourth switch turned off;
the first switch and the third switch turned on and the second switch and the fourth switch turned off; or
the first switch and the third switch turned off and the second switch and the fourth switch turned on.

16. A controller, comprising:
at least one processor, and
a memory, coupled to the at least one processor, and having instructions stored thereon, wherein the instructions, when executed by the at least one processor, cause the controller to perform the method according to claim 12.
